(19) United States
(12) Patent Application Publication
(10) Pub. No.: US 2026/0077644 A1
(43) Pub. Date: Mar. 19, 2026

(54) VEHICLE

(71) Applicant: ISUZU MOTORS LIMITED, Yokohama-shi (JP)

(72) Inventors: Yasushi YAMAMOTO, Fujisawa-shi (JP); Taku HONDA, Fujisawa-shi (JP); Koji TERASHIMA, Fujisawa-shi (JP); Yusuke TAKAHASHI, Fujisawa-shi (JP); Takahiko HATTORI, Fujisawa-shi (JP); Shinichi NISHITSU, Fujisawa-shi (JP)

(21) Appl. No.: 19/285,760

(22) Filed: Jul. 30, 2025

(30) Foreign Application Priority Data
Sep. 19, 2024 (JP) 2024-161964

(51) Int. Cl. B60K 6/46; B60K 6/24; B60K 6/26; B60K 6/28; B60K 11/04; B60K 13/04

(52) U.S. Cl. CPC B60K 6/46; B60K 6/24; B60K 6/26; B60K 6/28; B60K 11/04; B60K 13/04

(57) ABSTRACT

A vehicle includes a battery, a motor that receives electric power from the battery and generates power to be transmitted to wheels, a mounting portion on which a power generation unit, which includes an internal combustion engine and a first exhaust pipe through which exhaust gas from the internal combustion engine flows, is detachably mounted, and a muffler that is provided in the mounting portion and is connected to the first exhaust pipe when the power generation unit is mounted on the mounting portion.

### CROSS-REFERENCE TO RELATED APPLICATIONS

The present application claims priority to Japanese Patent Applications number 2024-161964, filed on Sep. 19, 2024 contents of which are incorporated herein by reference in their entirety.

### BACKGROUND OF THE INVENTION

The present disclosure relates to a vehicle.

Japanese Unexamined Patent Application Publication No. 2016-84769 discloses an electric vehicle equipped with a power generation unit including an internal combustion engine therein.

Electric power generated by the power generation unit is supplied to a battery of the electric vehicle.

In a power generation unit including an internal combustion engine, loud noise (exhaust noise) is generated by exhaust gas, and therefore, incorporation of a muffler within the power generation unit has been considered. The larger the volume of the muffler, the more effectively the exhaust noise can be reduced.

However, when the power generation unit is downsized, the volume of the muffler within the power generation unit becomes smaller, making it difficult to reduce the exhaust noise.

### BRIEF SUMMARY OF THE INVENTION

The present disclosure focuses on this point, and an object thereof is to reduce exhaust noise while downsizing a power generation unit including an internal combustion engine.

An aspect of the present disclosure provides a vehicle including a battery, a motor that receives electric power from the battery and generates power to be transmitted to wheels, a mounting portion on which a power generation unit, which i) includes an internal combustion engine and a first exhaust pipe through which exhaust gas from the internal combustion engine flows and ii) generates electric power capable of being supplied to the battery, is detachably mounted, and a muffler that is provided in the mounting portion and is connected to the first exhaust pipe when the power generation unit is mounted on the mounting portion.

### BRIEF DESCRIPTION OF THE DRAWINGS

FIG. 1 schematically shows a vehicle 1 according to a present embodiment.

FIG. 2 schematically shows the vehicle 1 according to the present embodiment.

FIG. 3 schematically shows a state where a power generation unit 50 is mounted on a mounting portion 20.

FIG. 4 schematically shows a state before the power generation unit 50 is mounted on the mounting portion 20.

FIG. 5 schematically shows a modification.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration of Vehicle

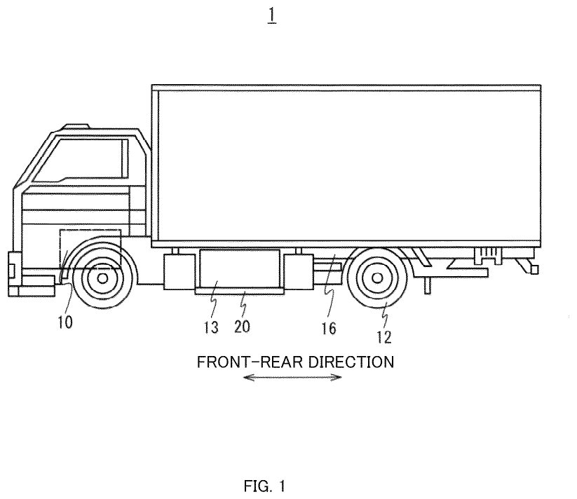

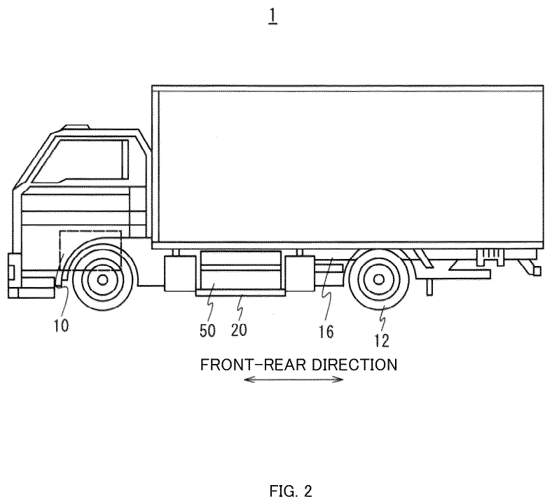

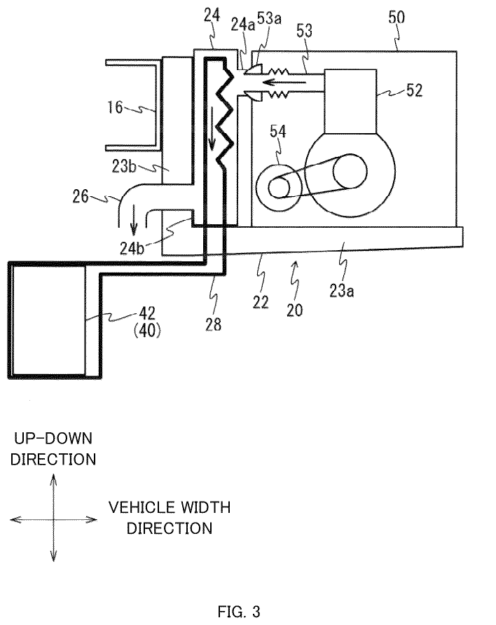

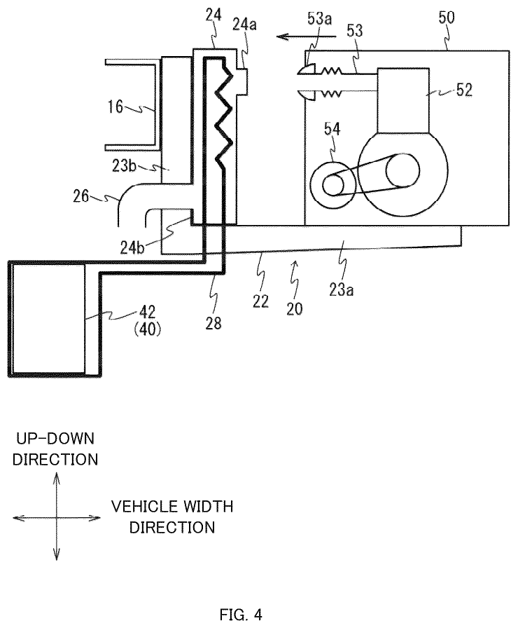

FIG. 1 and FIG. 2 schematically show a vehicle 1 according to a present embodiment. FIG. 3 schematically shows a state where a power generation unit 50 is mounted on a mounting portion 20. FIG. 4 schematically shows a state before the power generation unit 50 is mounted on the mounting portion 20. It should be noted that FIG. 1 shows a state in which a replaceable battery 13 is mounted on the mounting portion 20, and FIG. 2 shows a state in which the power generation unit 50 is mounted on the mounting portion 20. In FIG. 3, the flow of exhaust gas from an engine 52 is indicated by arrows.

The vehicle 1 is an electric vehicle, and specifically, a Battery Electric Vehicle (BEV). The vehicle 1 travels by driving a motor using electricity stored in a battery as a power source. The vehicle 1 here is a truck having a frame structure. As shown in FIG. 1, the vehicle 1 includes a motor 10, the replaceable battery 13, a side frame 16, and a mounting portion 20.

The motor 10 is a drive source that causes the vehicle 1 to travel. The motor 10 generates a driving force to be transmitted to wheels 12 of the vehicle 1. The motor 10 generates the driving force by receiving electric power from the replaceable battery 13.

The replaceable battery 13 is a battery that can be replaced. The replaceable battery 13 is a secondary battery that can be repeatedly charged. The replaceable battery 13 is a lithium-ion battery, for example. The replaceable battery 13 is chargeable from an external charger.

The side frame 16 is a vehicle body frame that forms a structural framework supporting the vehicle 1. The side frame 16 has a U-shaped cross-sectional shape (see FIG. 3). The side frame 16 is provided along the front-rear direction of the vehicle 1. The motor 10 and the replaceable battery 13 are mounted on the side frame 16. It should be noted that, in FIG. 1, the replaceable battery 13 is mounted on the left side (near side as viewed in FIG. 1) of the side frame 16 in the vehicle width direction, but in practice, a replaceable battery 13 is also mounted on the right side (far side as viewed in FIG. 1) of the side frame 16 in the vehicle width direction. That is, in FIG. 1, a plurality of replaceable batteries 13 (two replaceable batteries 13) are mounted on the side frame 16.

As shown in FIG. 1, the mounting portion 20 is a portion on which the replaceable battery 13 is detachably mounted. The mounting portion 20 is provided on the side frame 16. The mounting portion 20 is provided so as to be exposed to the outside, thereby facilitating mounting and removal of the replaceable battery 13 on and from the mounting portion 20.

As shown in FIG. 2, instead of one of the plurality of replaceable batteries 13, the power generation unit 50 can be detachably mounted on the mounting portion 20. In other words, either the power generation unit 50 or the replaceable battery 13 is detachably mounted on the mounting portion 20. In the present embodiment, the power generation unit 50 is configured to have substantially the same size as the replaceable battery 13 so that the power generation unit 50 can be easily mounted on the mounting portion 20.

The power generation unit 50 is a unit that generates electric power that can be supplied to the replaceable battery 13 (here, the replaceable battery 13 is located on the right side of the side frame 16 in the vehicle width direction). As shown in FIG. 3, the engine 52, which is an internal combustion engine, and a first exhaust pipe 53, through which exhaust gas from the engine 52 flows, are provided inside the power generation unit 50. Further, a generator 54 connected to an output shaft of the engine 52 and a fuel tank for supplying fuel to the engine are provided inside the power generation unit 50. The generator 54 is connected to the output shaft of the engine 52 via a belt and a pulley. When the power generation unit 50 is mounted on the mounting portion 20, electric power generated by the generator 54 by driving the engine 52 is supplied to the replaceable battery 13 via an inverter and a power line. The electric power generated by the power generation unit 50 is stored in the replaceable battery 13, thereby increasing the travel distance of the vehicle 1.

In the power generation unit 50, since loud noise (exhaust noise) is generated by exhaust gas from the engine 52, it is desirable to provide a muffler. The larger the volume of the muffler is, the more the exhaust noise can be reduced. However, when the power generation unit 50 is downsized, the volume of the muffler within the power generation unit 50 becomes smaller, making it difficult to reduce the exhaust noise.

In contrast, in the present embodiment, instead of being provided in the power generation unit 50, the muffler 24 is provided to the mounting portion 20 to take measures against the exhaust noise. Providing the muffler 24 in the mounting portion 20 as shown in FIG. 3 allows the volume of muffler 24 to be increased even when the power generation unit 50 is downsized, which in turn makes it possible to reduce the exhaust noise.

### Detailed Configuration of Mounting Portion

A detailed configuration of the mounting portion 20 will be described with reference to FIG. 3 and FIG. 4. As shown in FIG. 3, the mounting portion 20 includes a bracket 22, the muffler 24, a second exhaust pipe 26, and a cooling water pipe 28.

The bracket 22 is connected to the side frame 16. The power generation unit 50 is detachably mounted on the bracket 22. In addition, the replaceable battery 13 is detachably mounted on the bracket 22 instead of the power generation unit 50.

A pair of brackets 22 are provided on both sides of the vehicle 1 in the vehicle width direction. Each bracket in the pair of brackets 22 is connected to the side frame 16 of the vehicle 1. Since configurations of brackets in the pair of brackets 22 are the same, the detailed configuration of one of the brackets 22 will be described below.

The bracket 22 is a sheet metal member, and is fixed to the side frame 16 by a fastening member. The bracket 22 is provided so as to be exposed to the outside. The bracket 22 is L-shaped as an example, and includes a first plate portion 23a and a second plate portion 23b.

Here, the first plate portion 23a is a horizontal plate provided parallel to the horizontal direction (vehicle width direction). The first plate portion 23a supports the power generation unit 50 when the power generation unit 50 is mounted on the mounting portion 20. The first plate portion 23a supports the replaceable battery 13 when the replaceable battery 13 is mounted on the mounting portion 20. The power generation unit 50 and the replaceable battery 13 are mounted on the mounting portion 20 while sliding on the first plate portion 23a (see FIG. 4). The first plate portion 23a is provided with a fixing portion for fixing the power generation unit 50 or the replaceable battery 13.

The second plate portion 23b is provided so as to be orthogonal to the first plate portion 23a. Specifically, the second plate portion 23b is a vertical plate provided parallel to the vertical direction (up-down direction). The second plate portion 23b is in contact with the side frame 16, and is fixed to the side frame 16 by a fastening member. The second plate portion 23b supports the muffler 24. The second plate portion 23b is in contact with the muffler 24.

The muffler 24 is a silencer for suppressing exhaust noise generated by exhaust gas. A space through which the exhaust gas flows is formed inside the muffler 24. The muffler 24 is provided in the mounting portion 20. Specifically, the muffler 24 is installed to the bracket 22 of the mounting portion 20. When the power generation unit 50 is mounted on the mounting portion 20, the muffler 24 is connected to the first exhaust pipe 53 of the power generation unit 50, as shown in FIG. 3. Thus, the exhaust gas generated when the engine 52 of the power generation unit 50 is operated flows from the first exhaust pipe 53 to the muffler 24. The exhaust noise generated by the exhaust gas is reduced when the exhaust gas passes through the muffler 24.

In the present embodiment, since the muffler 24 is installed to the bracket 22 outside the power generation unit 50, the volume of the muffler 24 is increased (in other words, the size of the muffler 24 is increased) as compared with the case where the muffler 24 is provided inside the power generation unit 50. The muffler 24 having such an increased volume can further reduce the exhaust noise generated by the exhaust gas flowing from the first exhaust pipe 53.

The muffler 24 is provided so as to face the second plate portion 23b of the bracket 22. Specifically, the muffler 24 is provided in parallel with the second plate portion 23b. The muffler 24 is sandwiched between the second plate portion 23b and the power generation unit 50. The muffler 24 is disposed along the up-down direction, and the length of the muffler 24 in the up-down direction is substantially the same as that of the power generation unit 50 in the up-down direction.

One end portion 24a of the muffler 24 in the up-down direction is connected to the first exhaust pipe 53 when the power generation unit 50 is mounted on the mounting portion 20. Specifically, as shown in FIG. 3, the one end portion 24a of the muffler 24 is connected to a connecting portion 53a provided at a distal end of the first exhaust pipe 53. The one end portion 24a of the muffler 24 is exposed to the outside, as shown in FIG. 4, when the power generation unit 50 is not mounted on the mounting portion 20.

The second exhaust pipe 26 is connected to other end portion 24b of the muffler 24 in the up-down direction. The second exhaust pipe 26 is installed to the second plate portion 23b of the bracket 22. The second exhaust pipe 26 penetrates the bracket 22. Specifically, the second exhaust pipe 26 is installed so as to penetrate the second plate portion 23b. Thus, the second exhaust pipe 26 can be easily connected to the muffler 24 installed in the bracket 22. The second exhaust pipe 26 discharges the exhaust gas from the power generation unit 50 to the outside when the power generation unit 50 is mounted on the mounting portion 20. Specifically, the second exhaust pipe 26 discharges the exhaust gas downward in the up-down direction. Thus, the exhaust gas whose exhaust noise has been reduced by the muffler 24 is discharged to the outside through the second exhaust pipe 26.

The cooling water pipe 28 is a flow path through which cooling water capable of exchanging heat with exhaust gas flows. The cooling water pipe 28 is provided so as to pass through the muffler 24. Specifically, a portion (one end portion) of the cooling water pipe 28 is provided in the muffler 24. Therefore, the exhaust gas and the cooling water exchange heat in the muffler 24, thereby warming the cooling water by the exhaust gas. That is, the cooling water is heated by effectively utilizing the heat of the exhaust gas discharged from the power generation unit 50. It should be noted that, in FIG. 3 and FIG. 4, the cooling water pipe 28 penetrates the bracket 22 (specifically, the first plate portion 23a), but the cooling water pipe 28 may be provided so as to bypass the bracket 22.

The cooling water pipe 28 is disposed in the muffler 24 from the one end portion 24a to the other end portion 24b in the up-down direction. Specifically, the cooling water pipe 28 is disposed from the connecting portion with the first exhaust pipe 53 to the connecting portion with the second exhaust pipe 26. This enables the cooling water flowing through the cooling water pipe 28 to exchange heat with the exhaust gas over a wide area of the muffler 24, and thus heating of the cooling water is promoted.

The cooling water pipe 28 is connected to an external device 40 provided outside the muffler 24. The external device 40 is provided in the vehicle 1, and is a battery (hereinafter, referred to as a second battery) 42, for example. The second battery 42 stores electric power to be supplied to an auxiliary device of the vehicle 1, for example. It is known that the performance of the second battery 42 deteriorates when the temperature of the second battery 42 falls below a desired temperature.

Therefore, in the present embodiment, the cooling water pipe 28 is provided so as to be in contact with the second battery 42, and the second battery 42 is heated by the cooling water flowing through the cooling water pipe 28. That is, the cooling water heated by heat exchange with the exhaust gas in the muffler 24 flows through the cooling water pipe 28 to heat the second battery 42. This suppresses the temperature of the second battery 42 from being lower than the desired temperature, thereby suppressing a decrease in the performance of the second battery 42.

It should be noted that, in the above description, the external device 40 is the second battery 42, but the present disclosure is not limited thereto. For example, the external device 40 may be a heating device provided in the vehicle 1. Thus, the heating device can heat the interior of the vehicle 1 using the heat of the cooling water heated by the muffler 24.

Furthermore, the external device 40 may be a radiator that cools the cooling water. The radiator cools the cooling water with air (e.g., traveling wind generated during vehicle travel). In this case, the cooling water cooled by the radiator flows through the cooling water pipe 28 to exchange heat with the exhaust gas from the power generation unit 50 in the muffler 24, thereby lowering the temperature of the exhaust gas. When the temperature of the exhaust gas decreases, the exhaust noise generated by the exhaust gas decreases.

It should be noted that, when the replaceable battery 13 is mounted on the mounting portion 20, the cooling water cooled by the radiator can cool the replaceable battery 13 that has become high in temperature when passing through the interior of the muffler 24. Since the performance of the replaceable battery 13 deteriorates when the temperature of the replaceable battery 13 is too high, the performance of the replaceable battery 13 can be prevented from deteriorating by cooling the replaceable battery 13 with the cooling water and maintaining the temperature of the replaceable battery 13 at or below a desired temperature.

Both the second battery 42 and the radiator may be provided as the external device 40. In this case, it is desirable to provide a switching valve in the cooling water pipe 28 to switch the flow of the cooling water to either the second battery 42 or the radiator.

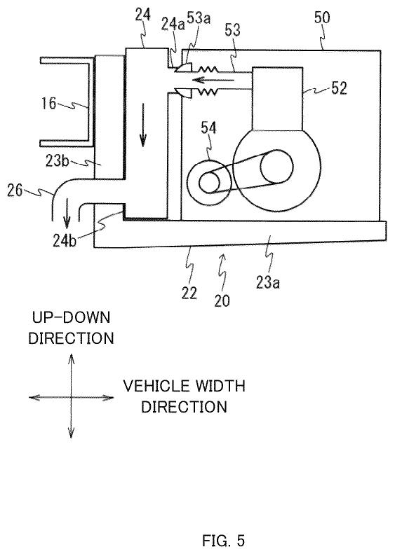

In the above description, the cooling water pipe 28 is provided in the muffler 24, but the present disclosure is not limited thereto. For example, as shown in FIG. 5, it is not necessary to provide the cooling water pipe 28 in the muffler 24. Also in this case, when the exhaust gas from the engine 52 of the power generation unit 50 passes through the muffler 24 provided in the mounting portion 20, the exhaust noise generated by the exhaust gas is suppressed. FIG. 5 schematically shows a modification.

### Effects of the Embodiment

The vehicle 1 of the above-described embodiment includes the mounting portion 20 on which the power generation unit 50 is detachably mounted, and the muffler 24 that is connected to the first exhaust pipe 53 of the power generation unit 50 when the power generation unit 50 is mounted on the mounting portion 20.

When the muffler 24 is provided to the mounting portion 20, the volume of the muffler 24 can be increased even when the size of the power generation unit 50 is reduced, thereby reducing the exhaust noise generated by the exhaust gas from the engine 52 of the power generation unit 50.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A vehicle comprising:
a battery;
a motor that receives electric power from the battery and generates power to be transmitted to wheels;
a mounting portion on which a power generation unit, which i) includes an internal combustion engine and a first exhaust pipe through which exhaust gas from the internal combustion engine flows and ii) generates electric power capable of being supplied to the battery, is detachably mounted; and
a muffler that is provided in the mounting portion and is connected to the first exhaust pipe when the power generation unit is mounted on the mounting portion.

2. The vehicle according to claim 1, further comprising:
a side frame that is provided along a front-rear direction of the vehicle, wherein
the mounting portion includes a bracket i) connected to the side frame and ii) on which the power generation unit is detachably mounted, and
the muffler is provided to the bracket.

3. The vehicle according to claim 2, wherein
the bracket includes:
a first plate portion that supports the mounted power generation unit, and
a second plate portion that is provided to be orthogonal to the first plate portion and configured to support the muffler.

4. The vehicle according to claim 1, wherein
one end portion of the muffler is connected to the first exhaust pipe when the power generation unit is mounted on the mounting portion, wherein
the vehicle further comprises:
a second exhaust pipe that is connected to an other end portion of the muffler and configured to discharge the exhaust gas to the outside.

5. The vehicle according to claim 4, wherein
the second exhaust pipe is provided so as to penetrate the bracket, and discharges the exhaust gas downward in an up-down direction.

6. The vehicle according to claim 1, wherein
either the power generation unit or the replaceable battery is detachably mounted on the mounting portion.

7. The vehicle according to claim 1, further comprising:
a cooling water pipe that is partially provided in the muffler and through which cooling water capable of exchanging heat with the exhaust gas flows, wherein
the cooling water pipe is connected to an external device provided outside the muffler.

8. The vehicle according to claim 7, wherein
the cooling water pipe is provided so as to be in contact with the battery, and
the battery is heated by the cooling water flowing through the cooling water pipe.

9. The vehicle according to claim 6, further comprising:
a cooling water pipe that is partially provided in the muffler and through which cooling water capable of exchanging heat with the exhaust gas flows, wherein
the cooling water pipe is provided outside the muffler and is connected to a radiator that cools the cooling water.
